(19) United States
(12) Patent Application Publication
(10) Pub. No.: US 2025/0279526 A1
(43) Pub. Date: Sep. 4, 2025

(54) Battery-Operated Machining Device

(71) Applicant: Robert Bosch GmbH, Stuttgart (DE)

(72) Inventors: Thomas Duerr, Asperg (DE); Andreas Rieger, Leinfelden-Echterdingen (DE); Michael Weiss, Stuttgart (DE)

(21) Appl. No.: 19/062,691

(22) Filed: Feb. 25, 2025

(30) Foreign Application Priority Data
Feb. 29, 2024 (DE) 10 2024 201 896.1

(51) Int. Cl. H01M 50/242; B25F 5/00; H01M 50/244; H01M 50/247; H01M 50/262

(52) U.S. Cl. CPC H01M 50/242; B25F 5/006; H01M 50/244; H01M 50/247; H01M 50/262; H01M 2220/30

(57) ABSTRACT

A battery-operated machining device includes a housing part, which at least partially surrounds an electronic unit and/or an electric motor for operating the machining device, a main handle, which is movably connected to the housing part for vibrational decoupling, and at least one electromechanical interface, which is arranged on the main handle and is provided for receiving an interchangeable battery pack such that the interchangeable battery pack can be released without tools, wherein the electromechanical interface has a protective housing, the envelope of which completely surrounds the received interchangeable battery pack. The protective housing is fixedly connected to the housing part and movably coupled to the main handle.

This application claims priority under 35 U.S.C. § 119 to application no. DE 10 2024 201 896.1, filed on Feb. 29, 2024 in Germany, the disclosure of which is incorporated herein by reference in its entirety.

The disclosure relates to a battery-operated machining device.

### BACKGROUND

From EP 3 653 344 A1, a battery-operated machining device in the form of a hand-held power tool is known, which comprises a housing part, the housing part at least partially surrounding an electronic unit and/or an electric motor for operating the machining device. For vibrational decoupling during a machining operation, a main handle of the machining device is movably connected to the housing part. An electromechanical interface for receiving an interchangeable battery pack such that the interchangeable battery pack can be released without tools is also arranged on the main handle, the electromechanical interface being surrounded by a protective bow which is fixedly connected to the main handle and which, when the interchangeable battery pack is received in the interface, surrounds the interchangeable battery pack on both sides, so that fall energy is at least partially absorbed by the protective bow and kept away from the interchangeable battery pack.

EP 2 080 594 A1 shows a battery-operated machining device which is in the form of a cordless screwdriver and in which the electromechanical interface arranged at a lower end of a main handle is surrounded by a protective housing fixedly connected to the main handle, such that the envelope of the protective housing completely surrounds the received interchangeable battery pack.

It is the object of the disclosure to ensure, in comparison with the prior art, improved protection for an interchangeable battery pack received in the electromechanical interface arranged on the main handle of a battery-operated machining device, in conjunction with the lowest possible vibrational load for the operator of the machining device.

### SUMMARY

To achieve the above object, it is provided that the protective housing is fixedly connected to the housing part of the machining device, which housing part surrounds the electronic unit and/or the electric motor, and that the protective housing is movably coupled to the main handle. Thus, in a particularly advantageous manner, the protective housing can absorb any impacts and falls particularly well by dissipating the impact energy into the housing part, while a high level of vibrational decoupling can be achieved a result of the movable coupling to the main handle. In this context, “the housing part” as part of the housing and “the housing part” as a separate, independent part should not be explicitly differentiated. This expression should be understood to cover both meanings.

For example, a battery-operated machining device is to be understood as a battery-operated power tool for machining workpieces using an electrically driven insertion tool. The battery-operated machining device can be designed not only as a hand-held power tool, but also as a stationary machine tool. Typical machine tools in this context include hand-held or stationary drills, screwdrivers, impact drills, planers, angle grinders, orbital sanders, polishing machines, or the like. However, suitable battery-operated machining devices also include garden tools and construction equipment, e.g. lawn mowers, lawn trimmers, branch saws, tilling and trenching machines, blowers, robotic breakers and excavators, etc., as well as measuring devices, e.g. laser rangefinders, wall scanners, etc. Furthermore, the disclosure is applicable to battery-operated household appliances such as vacuum cleaners, blenders, etc.

The energy supply of the battery-operated machining device is carried out by way of an interchangeable battery pack inserted into the at least one electromechanical interface. For this purpose, the interchangeable battery pack has an electromechanical interface which is complementary to said electromechanical interface. By way of these interfaces, the interchangeable battery pack and the battery-operated machining device can be frictionally and/or interlockingly releasably connected to each other. The term “releasable connection” is understood in particular to mean a connection that can be released and established without a tool, i.e., manually. The exact configuration of the electromechanical interfaces with their mechanical guide elements for the frictional and/or interlocking, releasable connection and with the electrical contacts used for energy and/or data transfer is not intended to be the subject of this disclosure. A person skilled in the art will choose a suitable embodiment for the electromechanical interfaces depending on the power class or voltage class of the battery-operated machining device and/or of the interchangeable battery pack, so that no further details will be given here. In addition, it should be noted that the disclosure is also applicable to battery-operated machining devices having a plurality of electromechanical interfaces for a plurality of interchangeable battery packs.

In a further development it is provided that the protective housing comprises, for movable coupling to the main handle, a mechanism which is configured to guide the main handle laterally and to support the protective housing on the main handle in the event of a fall or impact. In this way, a precise machining operation along a working axis of the machining device can be ensured, while, in the event of a fall or impact, the impact energy can be dissipated not only into the housing part fixedly connected to the protective housing but also into the main handle. Thus, by distributing the impact energy accordingly, the risk of damage to the machining device can be effectively reduced or completely avoided.

The protective housing has, on each of at least two outer sides, a contact surface in which the mechanism is arranged as a preferably removable support element. Because the mechanism can be removed from the main handle and/or from the protective housing, a simplified way to replace the main handle or the protective housing in the event of a defect is provided. In addition, it is possible to influence the degree of support on the main handle, for example in order to briefly allow very high vibrations without the main handle striking the protective housing. This may be advantageous, for example, in the case of machine guidance of the machining device in a guide device provided for this purpose.

Optimized support of the protective housing on the main handle can further be achieved when the contact surfaces of the protective housing are inclined towards the main handle. If the protective housing and/or the housing part each consist of two half shells along a central plane extending in the direction of the working axis of the machining device, the protective housing can be pushed towards the central plane in the event of a fall or impact so that the half shells do not gape apart. In addition, the half shells enable easier replacement of the individual parts of the machining device in the case of service and an advantageous assembly sequence.

In a further development, it is provided that at least one of the support elements is coupled to the main handle by way of a retaining element, in particular an elastic damping element or a screw. In this way it is possible, for example, to avoid noises in the event of abrupt impact of the support element against the protective housing. In addition, this enables simple replacement of the support element.

Alternatively, it can be provided that at least one of the support elements is fixedly connected, in particular integrally, to the main handle. In this way, it can be ensured that the support element is captively retained. An integral connection is intended in this context to mean that the connected elements cannot be non-destructively separated from one another. Particularly preferably, the support element and the main handle are made of the same material.

In addition, the protective housing and the housing part may also be formed as single piece in order to better dissipate the impact energy from the protective housing into the housing part. In this case the protective housing is integrally formed on the housing part, for example in the course of a plastic injection molding process or the like. Alternatively, the protective housing may also be fixedly connected to the housing part by a frictional connection, in particular a screw connection. The protective housing and/or the housing part are preferably made of a plastic material, for example PA6GF35, ABS or an elastomer. In addition or alternatively, another natural material, a metal (steel, aluminum, etc.) or a mix of materials is also conceivable.

It is further provided that the protective housing has a honeycomb structure which, in particular, is irregular. This results in reduced weight of the machining device and further improved dissipation of the impact energy together with increased intrinsic stability, in comparison with a full-volume or solid protective housing. An irregular honeycomb structure is to be understood to mean that the individual honeycombs can have different sizes and shapes. Thus, it is conceivable that, in regions in which greater stability is required, the honeycombs are more closely meshed and smaller and may have a structure that deviates from a hexagonal honeycomb structure.

### EXEMPLARY EMBODIMENTS

### Brief Description of the Drawings

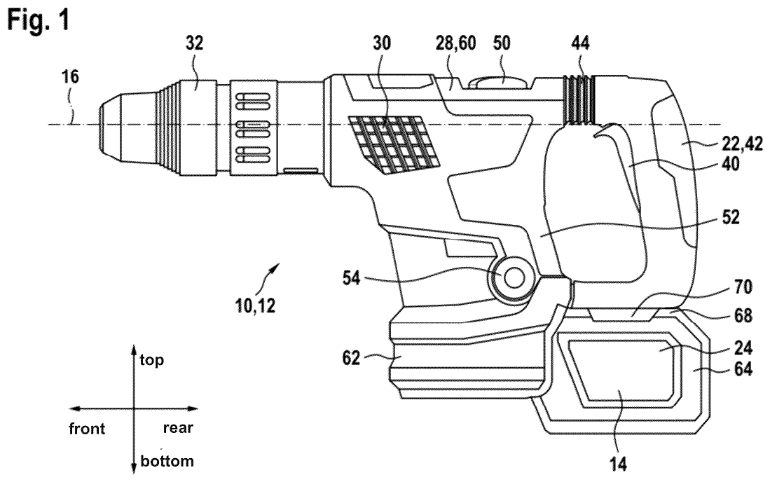

The disclosure is explained below with reference to FIGS. 1 through 7 by way of example, wherein identical reference numbers in the drawings indicate identical components having an identical function.

### Shown are:

FIG. 1: a side view of an exemplary embodiment of a battery-operated machining device in the form of a hammer drill, having a protective housing according to the disclosure for an interchangeable battery pack inserted into an electromechanical interface of the hammer drill,

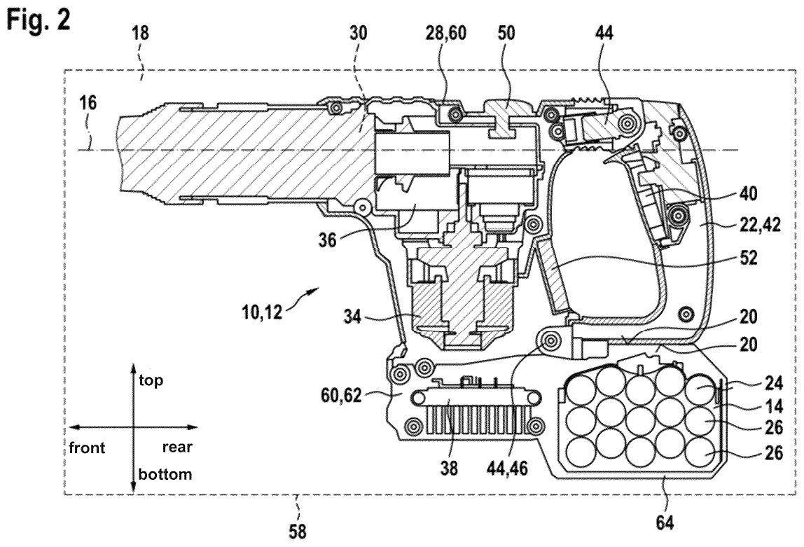

FIG. 2: the exemplary embodiment according to FIG. 1 in a sectional view along a central plane extending parallel to a working axis,

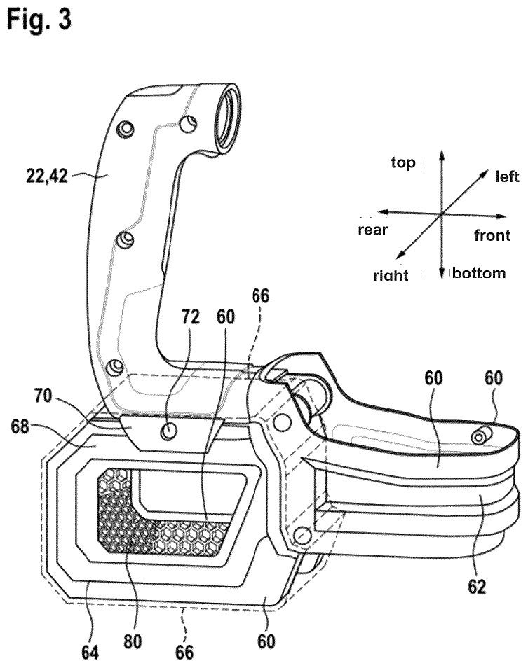

FIG. 3: a perspective partial view of the hammer drill according to FIGS. 1 and 2, the perspective partial view comprising a main handle, a housing part and the protective housing,

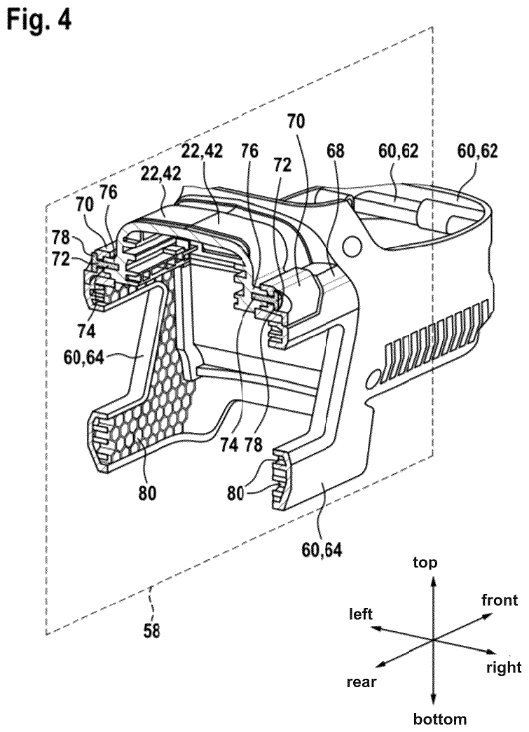

FIG. 4: a section through the protective housing according to FIG. 3 perpendicular to the central plane, and

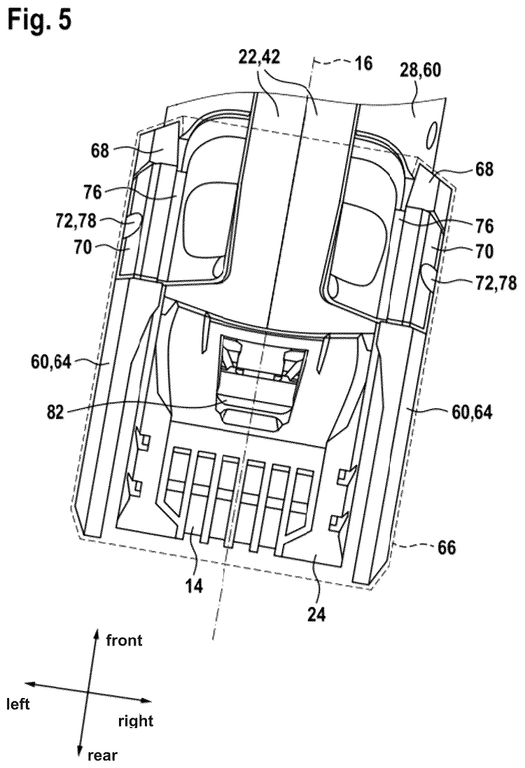

FIG. 5: a top plan view of the protective housing of the hammer drill according to FIGS. 1 to 4.

### DETAILED DESCRIPTION

FIGS. 1 and 2 show a battery-operated machining device 12 which is in the form of a hammer drill 10 and which is supplied with energy by an interchangeable battery pack 14, in a side view and in a section along a central plane 18 extending parallel to a working axis 16 of the machining device 12. For better orientation, coordinate crosses with the designations “rear”, “front”, “bottom” and “top” are shown in FIGS. 1 and 2. However, these designations are not to be understood as limiting the disclosure and refer primarily to a working direction extending along the working axis 16 and thus to the holding of the hammer drill 10 by an operator, in particular during a machining operation.

The interchangeable battery pack 14 can be frictionally and/or interlockingly releasably connected to the hammer drill 10 by way of correspondingly designed electromechanical interfaces 20 on the interchangeable battery pack 14 and on a lower end of a main handle 22 of the hammer drill 10. For this purpose, the operator can insert and lock the electromechanical interface 20 of the interchangeable battery pack 14 into the electromechanical mating interface 20 of the hammer drill 10. It should be noted that the overall design of the electromechanical interfaces 20 of the interlocking battery pack 14 and of the machining device 12 that can be connected thereto, and the associated receptacles for the frictional and/or interlocking releasable connection, are not intended to be the subject of this disclosure. A person skilled in the art will choose a suitable embodiment for the interfaces 20 depending on the power class or voltage class of the machining device 12 and/or of the interchangeable battery pack 14.

A housing 24 of the interchangeable battery pack 14 has, on a first side wall or its upper side, the first electromechanical interface 20 for releasable connection to the electromechanical mating interface 20 of the hammer drill 10. The interchangeable battery pack 14 is discharged during operation of the hammer drill 10. The voltage class of the interchangeable battery pack 14 results from the connection (parallel or serial) of the individual energy storage cells 26 integrated in the interchangeable battery pack 14 and is usually an integer multiple (>=1) of the voltage of the individual energy storage cells 26. An energy storage cell 26 is typically designed as a galvanic cell which has a structure in which one cell pole comes to lie at one end and a further cell pole comes to lie at an opposite end. In particular, the energy storage cell 26 has a positive cell pole at one end and a negative cell pole at an opposite end. Preferably, the energy storage cells 26 are designed as lithium-based round cells, e.g., Li-ion, Li-cell polymer, Li-metal, or the like, wherein the cell poles are arranged at the ends of the cylinder shape. However, the disclosure can also be applied to Ni—Cd, Ni-Mh cells or other suitable cell types. In the case of common Li-ion energy storage cells 26 with a cell voltage of 3.6 V, voltage classes of 3.6 V, 7.2 V, 10.8 V, 14.4 V, 18 V, 36 V, etc. result, for example. However, the disclosure does not depend on the type and design of the energy storage cells 26 used, but can be applied to any interchangeable battery packs 14 that use prismatic cells, pouch cells or the like instead of round cells. The DC voltage values are primarily based on the typical cell voltages of the energy storage cells 26 used. For pouch cells and/or cells with a different electrochemical composition, for example, voltage values that differ from the voltage values of the interchangeable battery packs 14 equipped with Li-ion cells are possible. In the following, the disclosure is described by way of example for an interchangeable battery pack 14 with a voltage class of 18 V.

The hammer drill 10 comprises a housing 28 in which a percussion mechanism 30 is at least partially arranged, the percussion mechanism being used to rotationally and/or percussively drive an insertion tool (not shown), such as a drill bit or a chisel, which can be alternately held in a drill chuck 32 arranged at the front end of the hammer drill. The percussion mechanism 30 is driven by an electric motor 34 together with a downstream transmission 36, the electric motor being arranged in the housing 28 and being supplied with energy by an electronic unit 38, which consists of a power electronics unit and an open- or closed-loop control unit. The electronic unit 38 is controlled for the closed- or open-loop control of the electric motor 34 according to a main button 40 which can be actuated by the operator, such that a desired speed and/or a desired torque of the electric motor 34 and of the drill chuck 32 driven by the electric motor can be set according to the pressing travel of the main button 40. The main button 40 is arranged in the main handle 22 of the hammer drill 10, the main handle being formed essentially by two half shells formed as handle shells 42. The two handle shells 42 are at least partially covered with a soft component in order to achieve an improved and more comfortable grip for the operator. The soft component is preferably in the form of a thermoplastic elastomer (TPE). Furthermore, the main handle 22 is decoupled from the housing 28 by an attenuating device 44 at the upper part of the main handle such that vibration is damped, in order to protect the operator from excessive vibrations during long work processes. The attenuating device 44 also comprises an articulated connection 46 at the lower end of the main handle 22, by which articulated connection the main handle 22 is movably coupled to the housing 22. For better guidance of the hammer drill 10, an optional additional handle (not shown in the figures) may be provided near the drill chuck 32. The further the main button 40 is pushed into the main handle 22, the higher the speed of the electric motor 34 is. When the main button 40 is released, it automatically moves out and the electric motor 34 comes to a stop. For the speed and/or torque control of the electric motor 34 configured as an EC motor, the open- or closed-loop control unit controls the power bridge by pulse width modulation (PWM) such that the power bridge applies trapezoidal or nearly sinusoidal commutation to the individual phases of the EC motor in a known manner.

By way of an operating mode selection switch 50 accommodated in the housing 28, the operator can switch between different operating modes, such as a drilling mode, a hammer drilling mode, or a chiseling or hammering mode. The operator can also use the main button 40 to vary the speed and/or torque of the electric motor 34 and thus of the insertion tool or drill chuck 32 operatively connected by the percussion mechanism 30. A Human Machine Interface (HMI) 52 provides the operator with a wide range of information, for example about the state of charge of the connected interchangeable battery pack 14, about the set operating mode and about any operating faults, such as an excessive temperature or the like. Furthermore, the hammer drill 10 comprises an exchangeable or permanently integrated communication module 54 for exchanging data with an external device (not shown in detail in this case), e.g. a smartphone, a smart watch, a personal computer, a gateway, a cloud server, or the like. The communication module 54 can also be used to make various settings on the hammer drill 10, e.g. activating or deactivating a kickback control mode (KBC) or adaptive speed control, from the external device. For this purpose, the communication module 54 exchanges the data via radio, in particular WLAN, Bluetooth, LoRa, Zeegbee, or a comparable data protocol. A further detailed description of the battery-operated machining device 12 designed as a hammer drill 10 is omitted here, as this is only of minor importance regarding the disclosure and the hammer drill 10 is also only to be understood as an example of various battery-operated machining devices 12.

According to the sectional view in FIG. 2, the housing 28 of the hammer drill 10 consists, similarly to the main handle 22, along a central plane 58 extending in the direction of the working axis 16, of two half shells 60, which are open on one side and which accommodate the electric motor 34, the transmission 36 and a part of the percussion mechanism 30 of the hammer drill 10. After assembly of the hammer drill 10, the half shells 60 are held together by a plurality of threaded connections (not shown) at their respective, directly adjacent side edges. The housing 28 is adjoined not only by the main handle 22 connected to the housing 28 with vibrational decoupling but also by a housing part 62 surrounding the electronic unit 38. The housing part 62 consists, similarly to the housing 28 and to the main handle 22, of two half shells 60, which in the assembled state form a cup housing which is open on one side and which is interlockingly and/or frictionally connected to the housing 28 by way of a tongue-and-groove system. Alternatively, it is also conceivable that the housing part 62 is configured as a single-piece cup housing. It is also conceivable that the half shells 60 of the housing part 62 and the half shells 60 of the housing 28 form a single-piece construction unit in each case.

To protect an interchangeable battery pack 14 inserted into the electromagnetic interface 20 of the main handle 22, a protective housing 64 is fixedly connected to the housing part 62. The protective housing 64 is movably coupled to the main handle 22 and arranged around the electromechanical interface 20 of the main handle 22 such that the interchangeable battery pack 14 received in the electromechanical interface 20 is completely surrounded by an envelope 66 of the protective housing 56 (cf. also FIGS. 3 and 5 in this regard). Thus, in a particularly advantageous manner, the protective housing 64 can absorb any impacts and falls particularly well by dissipating the impact energy into the housing part 62, while a high level of vibrational decoupling can be achieved as a result of the movable coupling to the main handle 22.

Particularly preferably, the protective housing 64 and the housing part 62 are formed as a single piece in order to better dissipate the impact energy from the protective housing 64 into the housing portion 62. The protective housing 64 is integrally formed on the housing part 62, for example in the course of a plastic injection molding process or the like. Alternatively, the protective housing 64 may also be fixedly connected to the housing part 62 by a frictional connection, in particular a screw connection. All housing elements 22, 28, 42, 60, 62, 64 are preferably made of a plastic material, for example PA6GF35, ABS and/or an elastomer. In addition or alternatively, another natural material, a metal (steel, aluminum, etc.) or a mix of materials is also conceivable.

FIG. 3 shows a perspective partial view of the hammer drill 10 according to the previous FIGS. 1 and 2, the perspective partial view comprising the main handle 22, the housing part 62 and the protective housing 64. For better clarity, no interchangeable battery pack 14 inserted into the electromechanical interface 20 of the main handle 22 is shown in the partial view. In this regard, reference is made to FIGS. 2 and 5. In addition, due to the spatial representation the designations “left” and “right” have been added to the coordinate cross already used in FIGS. 1 and 2. For movable coupling to the main handle 22, the protective housing 64 comprises, on each of at least two outer sides, a contact surface 68 in which a preferably removable support element 70 is arranged such that the support element guides the main handle 22 laterally and supports the protective housing 64 in the event of a fall or impact on the main handle 22. In this way, a precise machining operation along the working axis 16 of the hammer drill 10 can be ensured, while, in the event of a fall or impact, the impact energy can be dissipated not only into the housing part 62 fixedly connected to the protective housing 64 but also into the main handle 22. Because the support elements 70 can be removed from the main handle 22 and/or from the protective housing 64, a simplified way to replace the main handle 22 or the protective housing 64 in the event of a defect is provided. In addition, it is possible to influence the degree of support on the main handle 22, for example in order to briefly allow very high vibrations without the main handle 22 striking the protective housing 64.

For optimized support of the protective housing 64 on the main handle 22, the contact surfaces 68 of the protective housing 64 are inclined towards the main handle 22. In the case of a protective housing 64 and/or housing part 62 consisting of two half shells 60, in the event of a fall or impact the protective housing 64 can thus be pushed towards the central plane 58 of the hammer drill 10 so that the half shells 60 do not gape apart.

The two support elements 70 are coupled, by way of one retaining element 72 each, to the main handle 22 or to its handle shells 42. Preferably, the retaining element 72 is in the form of an elastic damping element which consists of an elastomer or a rubber and one end of which engages, with reference to FIG. 4, in a cylindrical recess 74 of a protrusion 76 of the handle shell 42 through an opening of the support element 70 in the manner of a pin, for the purpose of interlocking and/or frictional connection. However, it is also conceivable that the retaining element 72 is in the form of a screw. For clarity, FIG. 4 shows a section through the protective housing 64 along an axis through the retaining elements 72 perpendicular to the central plane 58. At its other end, the retaining element 72 comprises a plate-like head 78 for retaining the support element 70 on the handle shell 42. In this way, the support element 70 can be easily exchanged by laterally pulling it off. Also, any noises in the event of abrupt impact of the support element 70 against the protective housing 64 can be reduced. Alternatively, it can be provided that each support element 70 is fixedly connected, in particular integrally, to a handle shell 42 of the main handle 22. In this way, it can be ensured that the support element 70 does not become lost. Particularly preferably, the support element 70 and the main handle 22 are then made of the same material.

The protective housing 64 has, on each of the inner sides of the two outer walls, a honeycomb structure 80 which, in particular, is irregular. This results in a reduced weight of the hammer drill 10 and improved dissipation of the impact energy together with increased intrinsic stability, in comparison with a full-volume or solid protective housing 64. In regions in which greater stability is required, the honeycombs can be more closely meshed and smaller and may have a structure that deviates from a hexagonal honeycomb structure.

FIG. 5 shows the protective housing 64 of the hammer drill 10 according to FIGS. 1 to 4 in a top plan view, the protective housing consisting of the two half shells 60. For better orientation, the coordinate cross and the working axis 16 are shown similarly to FIGS. 1 to 4. In contrast to FIGS. 3 and 4, the interchangeable battery pack 14 is inserted into the electromechanical interface 20 (not shown) of the main handle 22 consisting of the two handle shells 42. A locking device 82 is provided on the interchangeable battery pack 14, by way of which locking device the interchangeable battery pack 14 can be secured in the electromechanical interface 20 of the hammer drill 10, to prevent it from accidentally falling out. However, the exact design of the locking device 82 is not the subject of the disclosure, and therefore this is not to be discussed further.

As can be clearly seen, the inserted interchangeable battery pack 14 is completely surrounded by the envelope 66 of the protective housing 64. The protective housing 64 and the main handle 22 are movably coupled to each other by the support elements 70, which are arranged on the inclined contact surfaces 68 of the protective housing, and by the retaining elements 72, in the manner previously described.

Finally, it should be pointed out that the exemplary embodiment shown is not limited to FIGS. 1 to 4, nor to the hammer drill 10. These are therefore to be understood only as example.

What is claimed is:

1. A battery-operated machining device having an electronic unit and/or an electric motor for operating the machining device, comprising:
a housing part which at least partially surrounds the electronic unit and/or the electric motor;
a main handle which is movably connected to the housing part and configured for vibrational decoupling; and
at least one electromechanical interface which is arranged on the main handle and is configured to receive an interchangeable battery pack such that the interchangeable battery pack is releasable without tools,
wherein the electromechanical interface has a protective housing, the envelope of which completely surrounds the received interchangeable battery pack, and
wherein the protective housing is fixedly connected to the housing part and movably coupled to the main handle.

2. The battery-operated machining device according to claim 1, wherein the protective housing comprises, for movable coupling to the main handle, a guidance mechanism which is configured to guide the main handle laterally and to support the protective housing on the main handle in the event of a fall or impact.

3. The battery-operated machining device according to claim 2, wherein the protective housing has, on each of at least two outer sides, a contact surface in which the guidance mechanism is arranged as a removable support element.

4. The battery-operated machining device according to claim 3, wherein the contact surfaces of the protective housing are inclined towards the main handle.

5. The battery-operated machining device according to claim 3, wherein at least one of the support elements is coupled to the main handle by way of a retaining element.

6. The battery-operated machining device according to claim 5, wherein the retaining element is in the form of an elastic dampening element or a screw.

7. The battery-operated machining device according to claim 3, wherein at least one of the support elements is fixedly connected to the main handle.

8. The battery-operated machining device according to claim 1, wherein the protective housing and the housing part are formed as a single piece.

9. The battery-operated machining device according to claim 1, wherein the protective housing is fixedly connected to the housing part by a frictional connection.

10. The battery-operated machining device according to claim 1, wherein the housing part and the protective housing each consist of two half shells along a central plane extending in the direction of a working axis of the machining device.

11. The battery-operated machining device according to claim 1, wherein the protective housing has a honeycomb structure which is irregular.

12. The battery-operated machining device according to claim 3, wherein at least one of the support elements is integrally connected to the main handle.

13. The battery-operated machining device according to claim 9, wherein the protective housing is fixedly connected to the housing part by a screw connection.
